(19) United States
(12) Patent Application Publication
(10) Pub. No.: US 2008/0187368 A1
(43) Pub. Date: Aug. 7, 2008

(54) DRUM UNIT AND IMAGE FORMING APPARATUS EQUIPPED THEREWITH

(75) Inventors: Yukimasa Watanabe, Osaka-shi (JP); Shiho Kuboshima, Osaka-shi (JP); Hiroyuki Hazama, Osaka-shi (JP); Kazunari Hamasaki, Osaka-shi (JP); Sakae Saito, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/024,179

(22) Filed: Feb. 1, 2008

(30) Foreign Application Priority Data
Feb. 7, 2007 (JP) 2007-028090

(51) Int. Cl. G03G 15/08

(52) U.S. Cl. 399/286

(57) ABSTRACT

A drum unit (20) for forming a toner image includes a cylindrical-shaped metal tubular member (31), a flange member (40) attached to one end of the metal tubular member (31) and a ground plate (50) attached to the flange member (40) and having an outer peripheral edge formed with a connection claw (52) that is so bent by the inner peripheral surface of the metal tubular member (31) as to bite into the inner peripheral surface for establishment of electrical conduction between the metal tubular member (31) and the ground plate (50). The flange member (40) has an edge, and the bending of the connection claw is carried out about a support point (412) defined by the edge. A calculational bending angle (θ) at which the connection claw (52) is bent about the support point (412) is set in the range of 10 to 45 degrees.

### BACKGROUND OF THE INVENTION

1. Field of the Invention

The present invention relates to a drum unit for forming a toner image based on image data, and an image forming apparatus equipped with the drum unit.

2. Description of the Related Art

Generally, an image forming apparatus such as a copy machine, a printer or a facsimile machine includes a metal tubular member commonly called “photosensitive drum”, in which an outer peripheral surface of the metal tubular member is irradiated with light based on image data obtained through reading or image data transmitted from outside to form an electrostatic latent image thereon, and toner is supplied from a development unit to the electrostatic latent image to develop a toner image. The toner image is transferred onto a sheet. The metal tubular member is assembled and unitized with other associated components to form a drum unit.

Heretofore, the drum unit has been known such as disclosed, for example, in JP 10-319783A (hereinafter referred to as “Patent Publication 1”). This drum unit includes a metal tubular member (“drum tube” in the Patent Publication 1) made of an aluminum alloy and formed in a cylindrical shape, a circular disk-shaped flange member attached to an opening formed at one end of the metal tubular member, and a ground plate fixed to an inner peripheral surface of the flange member in a coaxial manner. The metal tubular member has an insulating film layered on an inner peripheral surface thereof. The insulating film is provided to prevent a toner image from having black spots due to a local discharge breakdown (leak) caused by a current flowing through the metal tubular member. This insulating film is also provided to avoid the occurrence of rust in the metal tubular member.

The ground plate has an outer peripheral edge formed with a plurality of connection claws (“claws” in the Patent Publication 1) each protruding from the outer peripheral edge. In conjunction with an operation of inserting the flange member into the metal tubular member, respective pointed distal ends of the connection claws are moved to scratch and partially scrape off the insulating film and then cut into the inner peripheral surface of the metal tubular member. In this manner, electrical connection between the ground plate and the metal tubular member is established through the connection claws. The ground plate is electrically connected to a drum shaft which is disposed to extend along the center axis of the flange member, and then the drum shaft is grounded via a given support frame.

Accordingly, when a photosensitive layer formed on an outer peripheral surface of the metal tubular member is irradiated with light, charges built up in the irradiated region of the photosensitive layer will be removed via the ground plate (i.e., the connection claws), the drum shaft and the support frame. If the metal tubular member is not adequately grounded, an electrostatic latent image is likely to be formed on the outer peripheral surface of the metal tubular member in a disordered or disarranged manner, resulting in failure of accurately performing an image forming operation. In view of avoiding such a problem, it is essential to ensure the grounding of the metal tubular member.

During the course of inserting the flange member into the metal tubular member, a reaction force exerted from the inner peripheral surface of the metal tubular member will induce not only bending of the connection claws but also deformation of the ground plate. This is likely to spoil adequate contact between the ground plate and the drum shaft, and preclude reliable electrical conduction therebetween. With a view to solving this problem, in the drum unit disclosed in the Patent Publication 1, the ground plate is reinforced in part to prevent deformation of the ground plate.

Aside from the drum unit disclosed in the Patent Publication 1, JP 04-356090A (hereinafter referred to as “Patent Publication 2”) also discloses a drum unit having a ground plate. The drum unit disclosed in the Patent Publication 2 includes a metal tubular member (“cylindrical-shaped conductive substrate” in the Patent Publication 2) and a ground plate (“metal plate” in the Patent Publication 2) having an outer peripheral edge formed with a plurality of connection claws (“legs” in the Patent Publication 2) each protruding from the outer peripheral edge. With a view to ensuring reliable electric conduction between the metal tubular member and the connection claws, a distance between respective distal ends of the connection claws disposed opposed to each other in a radial direction of the metal tubular member is set to be greater than an inner diameter of the metal tubular member by 1%.

The drum unit disclosed in the Patent Publication 1 is designed to provide the ground plate with the reinforced portion so as to prevent deformation of the ground plate. This inevitably leads to an increase in the number of component parts, resulting in increase in cost. Moreover, the Patent Publication 1 does not disclose any technical concept for obtaining reliable electrical conduction between the metal tubular member and each of the connection claws.

The drum unit disclosed in the Patent Publication 2 is intended to form the connection claws in the ground plate to protrude therefrom in such a manner that the distance between the respective distal ends of the connection claws disposed opposed to each other in the radial direction of the metal tubular member becomes greater than the inner diameter dimension of the metal tubular member by 1%.

However, even if the distance between the respective distal ends of the opposed connection claws is set to be greater than the inner diameter of the metal tubular member by 1%, the connection claw is likely to be unable to generate an elastic force, depending on an elastically bent state of the connection claws during the course of pushing a flange member into the metal tubular member. With inadequate elastic force by the connection claw, it is difficult to allow an inner peripheral surface of the metal tubular member to be partially cut off (i.e., scratched and scraped off) by the pointed distal ends of the connection claws in a reliable manner. This means failure in obtaining adequate electric conduction between the metal tubular member and the ground plate.

### SUMMARY OF THE INVENTION

In view of the above circumstances, it is an object of the present invention to provide a drum unit capable of invariably obtaining reliable electrical conduction between a metal tubular member and a ground plate to remove electrostatic charges from the metal tubular member by grounding. It is another object of the present invention to provide an image forming apparatus equipped with the drum unit.

In order to accomplish the foregoing object of the present invention, there is provided in accordance with the present invention a drum unit for forming a toner image. The drum unit includes a cylindrical-shaped metal tubular member having an outer peripheral surface on which the toner image is formed and an inner peripheral surface formed with an insulating film. The drum unit also includes a flange member attached to one end of the metal tubular member and a ground plate attached to the flange member for removing electrostatic charges charged in the metal tubular member. The ground plate has an outer peripheral edge formed with a connection claw that is so bent by the inner peripheral surface of the metal tubular member as to bite into the inner peripheral surface of the metal tubular member for establishment of electrical conduction between the metal tubular member and the ground plate. The flange member has an edge, and the bending of the connection claw is carried out about a support point defined by the edge of the flange member. A calculational bending angle at which the connection claw is bent about the support point is set in the range of 10 to 45 degrees.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is an explanatory sectional view showing one example of an image forming apparatus equipped with a drum unit of the present invention.

FIG. 2 is a partially-cutaway exploded perspective view showing the drum unit according to one embodiment of the present invention.

FIG. 3 is a partially-cutaway perspective view showing the drum unit in FIG. 2 after assembling.

FIG. 4 is a sectional view taken along the line IV-IV in FIG. 3.

FIG. 5 is a sectional view taken along the line V-V in FIG. 3.

FIGS. 6A to 6C are explanatory diagrams of a bending angle of a connection claw of a ground plate, wherein FIG. 6A, FIG. 6B and FIG. 6C are a front view of the ground plate to be attached to a flange member, a fragmentary enlarged sectional view showing a state just before the flange member is attached to a photosensitive drum, and a fragmentary enlarged sectional view showing a state after the flange member is attached to the photosensitive drum, respectively.

FIG. 7 is a graph showing a relationship between a calculational bending angle of the connection claw and a scratch depth in a metal tubular member.

### DETAILED DESCRIPTION OF THE PREFERRED EMBODIMENTS

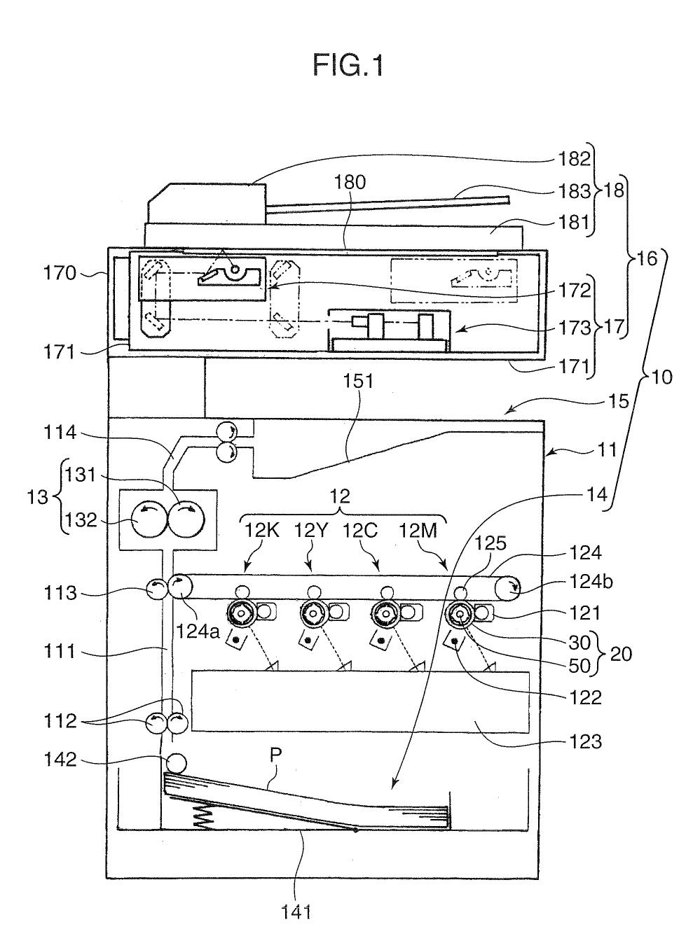

The following description will begin with an overview of an image forming apparatus equipped with a drum unit of the present invention. FIG. 1 is an explanatory sectional view showing one example of an image forming apparatus equipped with a drum unit of the present invention. As shown in FIG. 1, the image forming apparatus 10 is designed to be used as a copy machine, and fundamentally made up of a box-shaped main body 11 called “internal exit tray (wingless) type”, and an image reading section 16 provided above the main body 11 to read a document image. The image reading section 16 includes a flat box-shaped exterior cover 170, an image reader 17 mounted inside the exterior cover 170, and an automatic document feeder 18 mounted on an upper portion of the exterior cover 170.

The main body 11 accommodates an image forming section 12 for forming an image based on image data read by the image reader 17, a fixing section 13 for fixing the image formed by the image forming section 12 and then transferred onto a sheet P, and a sheet storage section 14 for storing a transfer sheet P. The main body 11 has a top portion provided with a sheet ejection section 15 which includes an internal exit tray 151 for receiving a sheet P ejected from the fixing section 13.

The automatic document feeder 18 includes a document press cover 181 for covering a contact glass 180, fitted in a top opening of the image reader 17, by selective opening and closing and for holding a document in position placed on the contact glass 180, a document feed unit 182 disposed on an upper left side (in FIG. 1) of the document press cover 181, and a document loading tray 183 disposed to extend from a right portion (in FIG. 1) of the document feed unit 182 in a rightward and upward direction (in FIG. 1).

The document press cover 181 presses a document such as a book, placed on the contact glass 180, so as to allow a document image of the document to be read by the image reader 17 across the contact glass 180. The document press cover 181 is adapted to be selectively opened and closed in such a manner as to be rotated about a given pivot shaft (not shown) positioned on one side edge (on the reverse side of the drawing sheet of FIG. 1) of a top surface of the image reader 17.

The document feed unit 182 is operable to pick up a document from a batch of documents loaded on the document loading tray 183 on a one-by-one basis, and feed the document onto the contact glass 180. The image reader 17 performs reading of a surface (i.e., document image) of the document placed on the contact glass 180. After completion of the document reading, the document is ejected onto a top surface of the document press cover 181. The image data on the document read by the image reader 16 is converted into an electric signal, and the resulting electric signal is output to the image forming section 12.

The image reader 17 includes a box-shaped housing 171, a read unit 172 so housed in the housing 171 to be reciprocatable laterally (in FIG. 1) and adapted to emit light onto the surface of the document and then guide resulting reflected light in a predetermined direction, and a CCD unit 173 adapted to collect the reflected light from the read unit 172 and pick up the collected light as image data.

Specifically, a document image of a document placed on the contact glass 180 or fed from the document loading tray 183 onto the contact glass 180 through the document feed unit 182 is scanned by the light emitted from the read unit 172, and resulting reflected light is read as image data on the document by the CCD unit 173. The image data is converted into a digital signal and then the digital signal is output to an after-mentioned exposure unit 123.

The image read section 16 further includes a manual operation panel (not shown) for allowing an operator to manually input desired conditions of various operations, such as document read operation and copying operation. The manual operation panel is provided, but not shown, with a display panel, a numeric keypad, a start button, a mode selection key, etc.

The image forming section 12 is provided to form a toner image on a sheet fed from the sheet storage section 14. In this example, the image forming section 12 has a magenta sub-section 12M, a cyan sub-section 12C, a yellow sub-section 12Y and a black sub-section 12K, which are disposed in a direction from an upstream side (right side of the drawing sheet of FIG. 1) toward a downstream side (left side of the drawing sheet of FIG. 1) in this order.

Each of the four sub-sections 12M, 12C, 12Y, 12K includes a development unit 121, and a drum unit 20 having a photosensitive drum 30 and a ground plate 50. Each of the four drum units 20 is supplied with toner from the corresponding development unit 121 while being rotated in a counterclockwise direction (in FIG. 1), so as to form a toner image on an outer peripheral surface of the photosensitive drum 30. Each of the development units 121 is replenished with toner from a toner cartridge (not shown) put in the main body 11.

The image forming section 12 further includes four charge units 122 each disposed immediately below the corresponding photosensitive drum 30, and an exposure unit 123 disposed below the charge units 122. Each of the charge units 122 is operable to electrostatically charge the outer peripheral surface of the corresponding photosensitive drum 30 in a uniform manner. The exposure unit 123 is operable, based on the image data input from the image read section 16, to emit four laser beams corresponding to four colors M, C, Y, K onto the respective charged outer peripheral surfaces of the photosensitive drums 30. Through the above operations, an electrostatic latent image is formed on the outer peripheral surface of each of the photosensitive drums 30. Then, each of the development units 121 supplies toner to the electrostatic latent image formed on the outer peripheral surface of the corresponding photosensitive drum 30, so that the toner image is formed (i.e., developed) on the outer peripheral surface of each of the photosensitive drums 30.

A transfer belt (transfer member) 124 is arranged above the drum units 20 in such a manner that it is so wound around between a drive roller 124a and a driven roller 124b in tensioned manner as to be disposed in contact relation with each of the photosensitive drums 30. The transfer belt 124 moves endlessly between the drive roller 124a and the driven roller 124b in synchronization with rotation of the photosensitive drums 30 while being urged against, that is, held in contact with the outer peripheral surface of the photosensitive drum 30 by four transfer rollers 125 disposed opposed to the respective photosensitive drums 30.

In conjunction with the movement of the transfer belt 124, a magenta toner image is transferred from the photosensitive drum 30 of the magenta sub-section 12M onto a surface of the transfer belt 124. Subsequently, a cyan toner image, a yellow toner image and a black toner image are sequentially transferred onto the surface of the transfer belt 124, respectively, from the photosensitive drum 30 of the cyan sub-section 12C, the photosensitive drum 30 of the yellow sub-section 12Y, and the photosensitive drum 30 of the black sub-section 12K, in a superimposed manner. In this manner, a color toner image is formed on the surface of the transfer belt 124. Then, the toner image is transferred onto a sheet P transported from the sheet storage section 14.

Also, a sheet transport passage 111 is formed in a left region (in FIG. 1) of the image forming section 12 to extend in the main body 11 in a generally vertical direction. The sheet transport passage 111 is provided with a pair of transport rollers 112 adapted to be rotated so as to allow a sheet P from the sheet storage section 14 to be transported toward the transfer belt 124 which is being moved around the drive roller 124a. The sheet transport passage 111 is further provided with a transfer roller 113 disposed in opposed relation to the drive roller 124a and in contact relation with the surface of the transfer belt 124. Thus, during the transportation through the sheet transport passage 111, the sheet P is pressed and nipped between the transfer belt 124 and the transfer roller 113, and therefore the toner image on the transfer belt 124 is transferred onto the sheet P (this operation will hereinafter be referred to as “transfer operation”).

The fixing section 13 fixes the toner image transferred on the sheet P. The fixing section 13 includes a fixing roller 131 internally having an electric heating element serving as a heating source, and a pressing roller 132 disposed on a left side (in FIG. 1) of and in opposed relation to the fixing roller 131. After completion of the transfer operation, the sheet P is guided from the image forming section 12 through the sheet transport passage 111, and is then heated by the fixing roller 131, while being pressed and nipped between the fixing roller 131 and the pressing roller 132. Through this fixing operation, the toner image is fixed on the sheet P so that a color image is formed on the sheet P in a stable state.

After completion of the fixing operation, the color printed sheet P is ejected into the internal exit tray 151, provided in the top portion of the main body 11, through a sheet ejection passage 114 extending from an upper region of the fixing section 13.

The sheet storage section 14 has a sheet tray 141 mounted below the exposure unit 123 in a drawable manner. The sheet tray 141 is adapted to store thereon a sheet stack. The sheet storage section 14 is provided with a pickup roller 142 adapted to pick up a sheet P from the sheet stack on a one-by-one basis so as to allow the sheet P to be led to the image forming section 12 through the sheet transport passage 111.

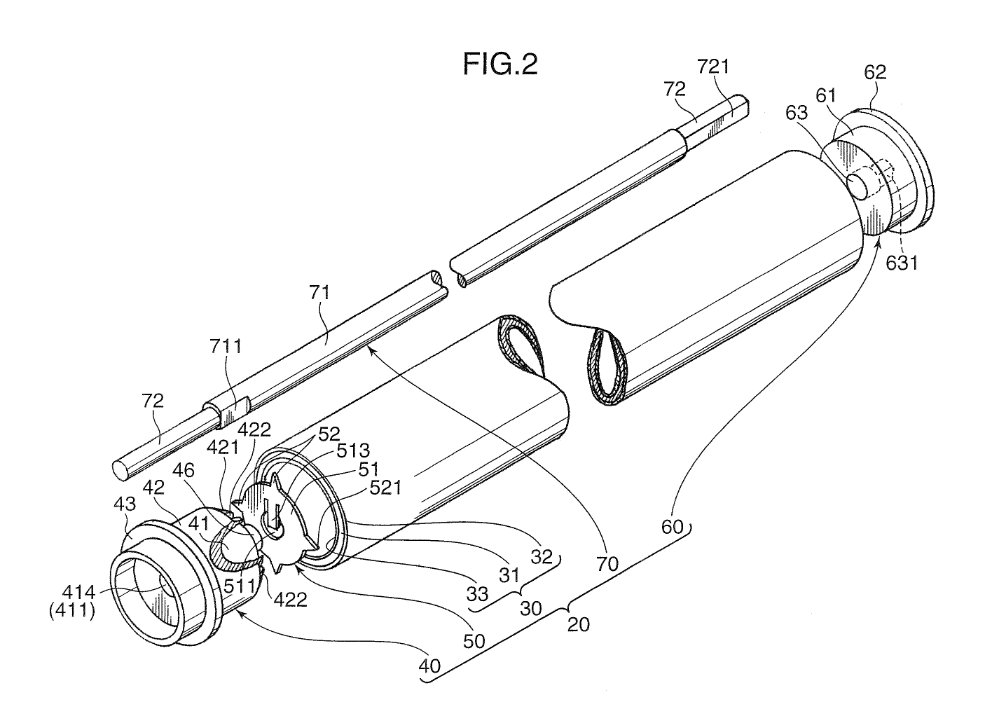

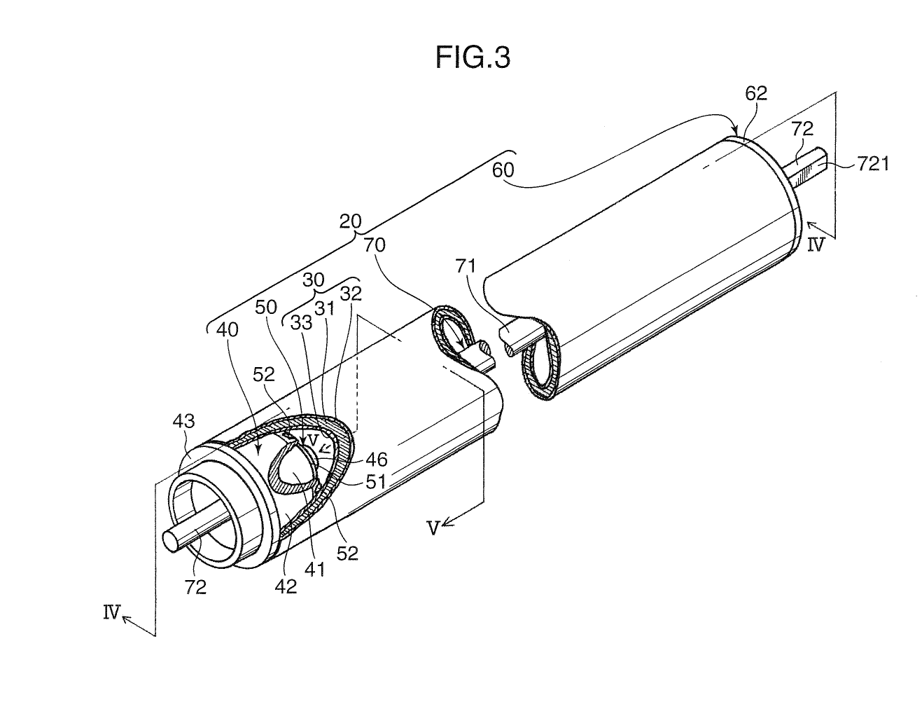

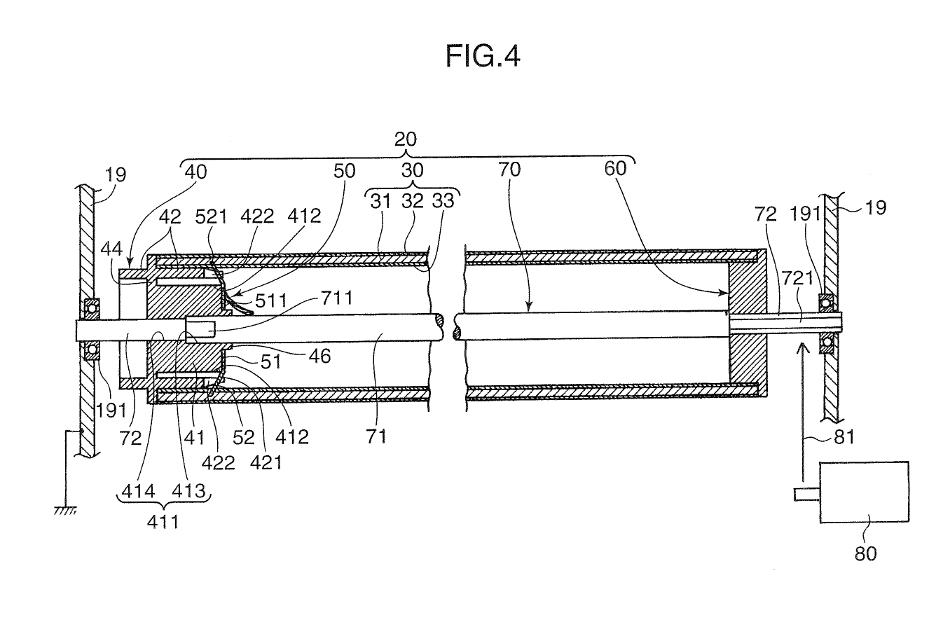

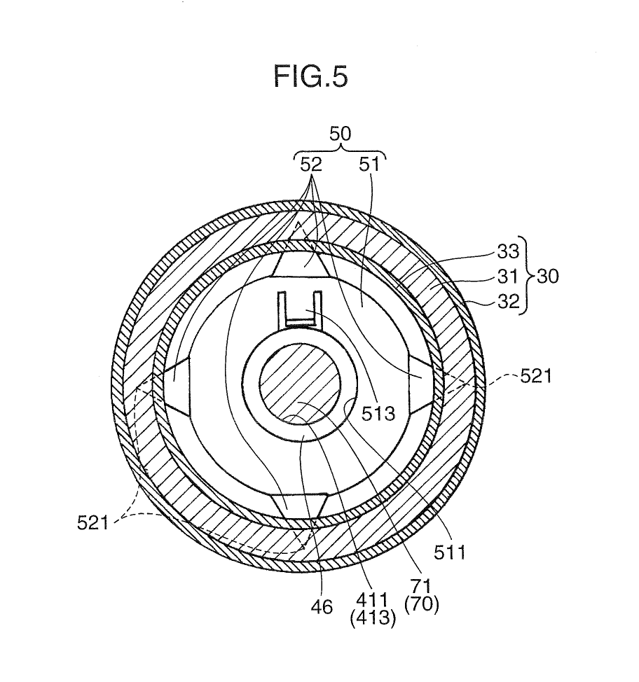

The drum unit 20 of the present invention, particularly the ground plate 50, will be specifically described based on FIGS. 2 to 5. FIG. 2 is a partially-cutaway exploded perspective view showing the drum unit 20 according to one embodiment of the present invention, and FIG. 3 is a partially-cutaway perspective view showing the drum unit 20 after assembling. FIG. 4 is a sectional view taken along the line IV-IV in FIG. 3, and FIG. 5 is a sectional view taken along the line V-V in FIG. 3. In FIGS. 2 to 5 (particularly FIG. 5), a thickness dimension of the photosensitive drum 30 is illustrated in an exaggerated manner.

As shown in FIG. 2, the drum unit 20 includes a cylindrical-shaped photosensitive drum 30 adapted to allow an electrostatic latent image and a toner image to be formed on an outer peripheral surface thereof, a flange member 40 fittingly inserted into an opening formed at one end (in FIG. 2, a left end) of the photosensitive drum 30, a ground plate 50 attached coaxially to the flange member 40, a shaft-supporting annular plate 60 attached to the other end (the right end in FIG. 2) of the photosensitive drum 30 in coaxial relation with photosensitive drum 30, and a drum shaft 70 disposed to extend through the flange member 40 and the shaft-supporting circular plate 60 in coaxial relation with the flange member 40 and the shaft-supporting annular plate 60 for integral rotation with the flange member 40 and the shaft-supporting circular plate 60.

The photosensitive drum 30 includes a metal tubular member 31 made of aluminum or aluminum alloy, an organic photosensitive layer 32 formed on an entire region of an outer peripheral surface of the metal tubular member 31, and an insulating film 33 formed on an entire region of an inner peripheral surface of the metal tubular member 31. The photosensitive drum 30 employed in this embodiment is designed to have an outer diameter of 24 to 30 mm. The metal tubular member 31 has a thickness dimension of several mm, whereas each of the organic photosensitive layer 32 and the insulating film 33 is formed to an extremely small thickness dimension of several μm to several ten μm.

The organic photosensitive layer 32 is made of an organic photosensitive material such as a charge transport agent, a charge generation agent and a binding resin (binder resin). As compared with conventional inorganic photoconductors, an organic photoconductor is advantageous in manufacturability and can offer a variety of options for photosensitive materials, which provides an advantage of increasing freedom in structural design. The organic photoconductor can be roughly classified into a monolayer-type photoconductor and a multilayer-type photoconductor. The monolayer-type photoconductor is preferable in view of applicability to both positively-chargeable type and negatively-chargeable type photoconductors, structural simplicity, capability to enhance manufacturability, capability to effectively suppress film defects during formation of a photosensitive layer, less interlayer interfaces and capability to enhance optical characteristics.

The insulating film 33 is provided to prevent a toner image from having black spots due to a local discharge breakdown (leak) in the organic photosensitive layer 32 caused by a current flowing through the metal tubular member 31. The insulating film 33 is also provided to avoid the occurrence of rust in the metal tubular member 31.

In this embodiment, the insulating film 33 is formed as an aluminum oxide (Al₂O₃) film or an aluminum alloy oxide film. Specifically, the insulating film 33 may be obtained by subjecting the inner peripheral surface of the metal tubular member 31 to an anodizing process using as an electrolyte an aqueous oxalic acid solution, an aqueous sulfuric acid solution or an aqueous chromic acid solution.

The flange member 40 includes a columnar-shaped inner flange body 41, a tubular-shaped outer flange body 42 disposed in coaxial relation with the inner flange body 41 to loosely receive the inner flange body 41 with an annular-shaped gap therebetween, and a flange wall 43 coaxially formed on the outer flange body 42 at a position on the side of one end (in FIG. 2, a left end) of the outer flange body 42. The inner flange body 41 is formed with a shaft hole 411 which extends along a longitudinal axis (center axis) of the inner flange body 41 to allow the drum shaft 70 to extend therethrough. The shaft hole 411 consists of a large-diameter hole portion 413 (see FIG. 4) for receiving an after-mentioned large-diameter shaft portion 71 of the drum shaft 70, and a small-diameter hole portion 414 for receiving an after-mentioned small-diameter shaft portion 72 of the drum shaft 70.

An annular-shaped wall 44 (see FIG. 4) is formed to bridge between an outer peripheral surface of the inner flange body 41 on a left end thereof (in FIG. 4) and an inner peripheral surface of the outer flange body 42, in coaxial relation with the inner flange body 41 and the outer flange body 42. In this manner, the inner flange body 41 and the outer flange body 42 are integrated together by the annular-shaped wall 44.

The inner flange body 41 has a tubular-shaped ground-plate mounting sleeve 46 formed on one end face thereof (right end face in FIGS. 2 and 4) which faces in a direction in which the inner flange member 41 (the flange member 40) is inserted into the photosensitive drum 30, which mounting sleeve 46 protrudes rightwardly from the right end face (in FIG. 4) in coaxial relation with the inner flange body 41. The ground plate 50 is attached to the flange member 40 in such a manner as to be fitted on an outer peripheral surface of the ground-plate mounting sleeve 46. The ground-plate mounting sleeve 46 has an inner diameter set to be equal to an inner diameter of the large-diameter hole portion 413 of the inner flange body 41, and an outer diameter set to be less than an outer diameter of the inner flange body 41.

The outer flange body 42 has an outer diameter set to be slightly smaller than the inner diameter of the metal tubular member 31. With this dimensional setting, the outer flange body 42 is inserted into the photosensitive drum 30 for engagement with the photosensitive drum 30.

The outer flange body 42 is formed with an annular-shaped inclined portion 421 at one end thereof (right end in FIG. 2) which faces in a direction in which the outer flange body 42 (the flange member 40) is inserted into the photosensitive drum 30 (in FIG. 2, a right end thereof), which inclined portion 421 has an outer diameter decreasing in the insertion direction of the outer flange body 42. Further, the annular-shaped inclined portion 421 has four cutout grooves 422 formed at 90-degree pitches by cutting in an axial direction of the outer flange body 42 from an edge of the inclined portion 421, when viewed in the axial direction of the outer flange body 42. The cutout grooves 422 are used to receive connection claws 52 of the ground plate 50, as described later.

The ground plate 50 is made of a metal material, having elasticity, such as stainless steel or brass. The ground plate 50 is provided as a means to establish an electrical conduction with the metal tubular member 31 after being inserted into the photosensitive drum 30.

The ground plate 50 has a circular-shaped ground-plate body 51 having an outer diameter approximately equal to the outer diameter of the inner flange body 41, and four connection claws 52 formed on an outer peripheral edge of the ground-plate body 51 at even pitches in a circumferential direction thereof to protrude radially outwardly from the outer peripheral edge of the ground-plate body 51.

The ground-plate body 51 has an insertion hole 511 coaxially formed in an central region thereof to allow the large-diameter shaft portion 71 of the drum shaft 70 to pass therethrough. The ground-plate mounting tube 46 (see FIG. 4) is fittingly inserted into the insertion hole 511 to mount the ground plate 50 onto the flange member 40.

The ground-plate body 51 has an inner peripheral edge formed with a connection piece 513 protruding toward a hole center of the insertion hole 511. The connection piece 513 is adapted, when the ground plate 50 is fitted on the large-diameter shaft portion 71 of the drum shaft 70, to be elastically deformed and brought into press abutment with an outer peripheral surface of the large-diameter shaft portion 71. This press abutment makes it possible to ensure reliable electric contact between the ground plate 50 and the drum shaft 70.

Each of the connection claws 52 is provided to obtain electrical connection with the metal tubular member 31 so as to allow the metal tubular member 31 to be grounded after the ground plate 50 is inserted into the photosensitive drum 30. In this embodiment, each of the connection claws 52 is formed in an isosceles triangle shape which has a base serving as an electrical connection end with the ground-plate body 51. Each of the connection claws 52 has a distal edge 521 formed in a pointed shape (i.e., an apex of the isosceles triangle shape) capable of partially cutting off (i.e., scratching and scraping off) the insulating film 33 formed on the inner peripheral surface of the photosensitive drum 30. In this embodiment, the connection claw 52 is provided in a number of four, wherein the four connection claws 52 are disposed along the circumferential direction of the ground-plate body 51 at even intervals, i.e., at 90-degree pitches, as described above.

A protruding distance of each of the connection claws 52 from the ground-plate body 51 is set at a value which allows the pointed distal edge 521 of the connection claw 52 to interfere with the inner peripheral surface of the photosensitive drum 30, cut off the insulating film 33 and reach the metal tubular member 31, during insertion of the flange member 40 into the photosensitive drum 30.

More specifically, each of the connection claws 52 is designed such that the diameter of the ground plate 50 in an unbent state (i.e., a double value of the distance between the center of the ground plate 50 and the pointed distal edge 521 of the connection claw 52) is greater than the inner diameter of the photosensitive drum 30 (specifically, the inner diameter of the metal tubular member 31), and a calculational bending angle of the connection claw 52 is in the range of 10 to 45 degrees. The definition of the term “calculational bending angle” will be described in detail later.

The shaft-supporting circular plate 60 is provided to close an opening formed at the other end of the photosensitive drum 30 on an opposite side of one end having the flange member 40 attached thereto. The shaft-supporting circular plate 60 has a columnar-shaped circular-plate body 61 having an outer diameter slightly greater than the inner diameter of the photosensitive drum 30, and a flange 62 coaxially formed on one end (right end in FIG. 2) of the circular-plate body 61. The flange 62 is formed to have an outer diameter equal to the outer diameter of the photosensitive drum 30.

The shaft-supporting circular plate 60 is formed with a shaft hole 63 extending along a center axis thereof to allow the small-diameter shaft portion 72 of the drum shaft 70 to extend therethrough. The shaft hole 63 has a key hole portion 631 which is a cross-sectionally D-shaped hole prepared by cutting off a part of an arc surface thereof to allow the arc surface to be formed into a flat surface.

The outer diameter of the circular-plate body 61 of the shaft-supporting circular plate 60 is set to be slightly greater than the inner diameter of the photosensitive drum 30 by several to several ten μm. Thus, the shaft-supporting circular plate 60 is fixed to the photosensitive drum 30 by pressing the circular-plate body 61 into the photosensitive drum 30 by press fitting.

The drum shaft 70 is disposed along the drum axis (longitudinal axis) of the photosensitive drum 30 for integral rotation with the photosensitive drum 30. The drum shaft 70 includes a large-diameter shaft portion 71, and first and second small-diameter shaft portions 72 coaxially protruding in opposite directions from respective opposite ends of the large-diameter shaft portion 71.

The large-diameter shaft portion 71 has a length that is set such that, in a state in which the flange member 40 and the shaft-supporting circular plate 60 are attached to the photosensitive drum 30, one end (left end in FIG. 2) of the large-diameter shaft portion 71 comes into contact with a step formed between the large-diameter and small-diameter hole portions 413, 414 of the inner flange body 41 of the flange member 40, whereas the other end of large-diameter shaft portion 71 comes into contact with a left end surface (in FIG. 2) of the circular-plate body 61.

Respective length dimensions of the first (in FIG. 2, left) small-diameter shaft portion 72 and the second (right in FIG. 2) small-diameter shaft portion 72 are set such that, in a state in which the drum shaft 70 is attached to the photosensitive drum 30, the first small-diameter shaft portion 72 protrudes from the flange member 40 to outside, whereas the second small-diameter shaft portion 72 protrudes from the shaft-supporting circular plate 60 to outside.

The large-diameter shaft portion 71 has an outer peripheral surface partially formed as a D-cut surface 711 at the left end (in FIG. 2) of the large-diameter shaft portion 71. Correspondingly, the large-diameter hole portion 413 of the flange member 40 is partially formed as a key hole portion (not shown) adapted to come into surface contact with the D-cut surface 711 of the large-diameter shaft portion 71. Thus, when the large-diameter shaft portion 71 is inserted into the large-diameter hole portion 413, the D-cut surface 711 is brought into contact with the key hole portion (not shown) to allow the flange member 40 to be rotated integrally with the drum shaft 70.

The second (in FIG. 2, right) small-diameter shaft portion 72 has an outer peripheral surface partially formed as a D-cut surface 721 corresponding to the key hole portion 631 formed in the shaft hole 63 of the shaft-supporting circular plate 60. Thus, when the second small-diameter shaft portion 72 is inserted into the shaft hole 63 of the shaft-supporting circular plate 60, the D-cut surface 721 of the second small-diameter shaft portion 72 is brought into contact with the key hole portion 631 to allow the shaft-supporting circular plate 60 to be rotated integrally with the drum shaft 70.

In the state in which the drum shaft 70 is inserted in the photosensitive drum 30 having the shaft-supporting circular plate 60 and the flange member 40 with the ground plate 50 attached thereto, the connection piece 513 of the ground plate 50 is in press abutment against the outer peripheral surface of the large-diameter shaft portion 71 so as to ensure reliable electrical connection between the drum shaft 70 and the photosensitive drum 30.

The drum unit 20 of the above structure is, as shown in FIG. 4, integrally rotated about the drum shaft 70 by a driving force transmitted from a drive motor 80 installed in the main body 11 to the small-diameter shaft portion 72 through a given gear mechanism 81.

The first (in FIG. 4, left) small-diameter shaft portion 72 is supported by a frame 19 provided inside the main body 11, through a bearing 191 disposed in the frame 19. The frame 19 is grounded. Thus, when the organic photosensitive layer 32 on the outer peripheral surface of the metal tubular member 31 is irradiated with light, charges built up in the irradiated region of the organic photosensitive layer 32 will be removed via the metal tubular member 31, the ground plate 50 (i.e., respective pointed distal ends 521 of the connection claws 52, the ground-plate body 51 and the connection piece 513), the drum shaft 70 (i.e., the large-diameter shaft portion 71 and the first small-diameter shaft portion 72), the bearing 191 and the frame 19.

The protruding distance of each of the connection claws 52 from the ground-plate body 51 is set at a value which allows the connection claw 52 to extend radially outwardly beyond the inner peripheral surface of the photosensitive drum 30, as described above. Thus, when the flange member 40 having the right end (in FIG. 2) attached with the ground plate 50 coaxially is pushed into the photosensitive drum 30, each of the connection claws 52 interferes with the inner peripheral surface of the photosensitive drum 30 in such a manner that the pointed distal end 521 of the connection claw 52 scratches and partially cuts off the insulating film 33 of the photosensitive drum 30. This makes it possible to allow the inner peripheral surface of the metal tubular member 31 to be electrically connected to the connection claws 52 through the pointed distal ends 521.

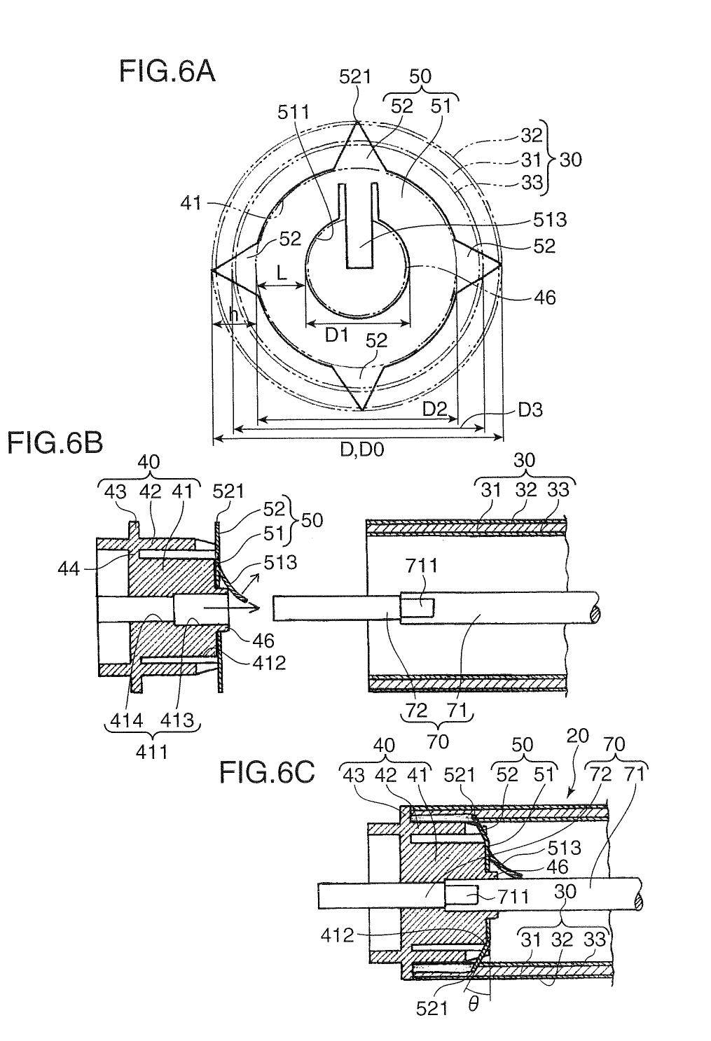

The following description will be made about a bending angle of each of the connection claws 52 of the ground plate 50, based on FIG. 6. FIGS. 6A to 6C are explanatory diagrams of the bending angle of the connection claw 52 of the ground plate 50, wherein FIG. 6A, FIG. 6B and FIG. 6C are a front view of the ground plate 50 to be attached to the flange member 40, a fragmentary enlarged sectional view showing a state just before the flange member 40 is attached to the photosensitive drum 30, and a fragmentary enlarged sectional view showing a state after the flange member 40 is attached to the photosensitive drum 30, respectively. In FIGS. 6A to 6C, the thickness of the metal tubular member 31, the thickness of the insulating film 33 and the protruding distance of the connection claw 52 from the ground-plate body 51 are illustrated in an exaggerated manner as compared with an actual value.

As shown in FIG. 6A, the insertion hole 511 formed in the central region of the ground-plate body 51 of the ground plate 50 has a diameter D1 set to be slightly greater than the outer diameter of the ground-plate mounting sleeve 46 of the flange member 40. Thus, when the ground-plate mounting sleeve 46 is inserted into the insertion hole 511 in a sliding manner, the ground plate 50 is stably attached to the flange member 40, as shown in FIG. 6B.

The ground-plate body 51 has an outer diameter D2 set to be equal to or slightly greater than the outer diameter of the inner flange body 41 of the flange member 40. In the ground plate 50 illustrated in FIGS. 6A to 6C, the outer diameter D2 of the ground-plate body 51 is set to be approximately equal to the outer diameter of the inner flange body 41 of the flange member 40.

The dimensional relationship between the photosensitive drum 30 and the ground plate 50 in the state in which the ground plate 50 is disposed in coaxial relation with and opposed to the photosensitive drum 30 is such that the protruding distance h of each of the connection claws 52 from the outer peripheral edge of the ground-plate body 51 is set to allow the pointed distal end 521 to reach the metal tubular member 31 beyond the insulating film 33 of the photosensitive drum 30. In the embodiment illustrated in FIG. 6A, the pointed distal end 521 of the connection claw 52 is located at a position corresponding to the outer peripheral surface of the photosensitive drum 30.

This means that a distance D between the respective pointed distal ends of two of the connection claws 52 located opposed to each other in a diametric direction of the ground-plate body 51 (i.e., a diameter of a virtual circle formed by connecting the respective pointed distal ends 521 around the hole center of the insertion hole 511) is set to be greater than an inner diameter D3 of the metal tubular member 31. In this embodiment, the ground-plate body 51 has a radial width L set to be one-half of the diameter D1 of the insertion hole 511.

When the ground plate 50 is attached inside the photosensitive drum 30, each of the connection claws 52 is bent about a support point defined by an edge formed between the outer peripheral surface and the right end face of the inner flange body 41 of the flange member 40. This support point serves as a bending point 412. The protruding distance h (see FIG. 6A) of the connection claw 52 from the bending point 412 is set such that a calculational bending angle θ (see FIG. 6C) at which the connection claw 52 is to be bent about the bending point 412 falls within the range of 10 to 45 degrees. This setting of the protruding distance h is made on the assumption that the aforementioned condition (D>D3>D2) is satisfied (i.e., the condition that a distance between the center of the ground plate 50 and the pointed distal end 521 of the connection claw 52 is greater than the radius of the metal tubular member 31 is satisfied).

As used in this specification, the term “calculational bending angle θ” means an angle which is simply calculable from the inner diameter of the metal tubular member 31 and the distance D between the respective pointed distal ends 521 of the opposed connection claws 52, on the assumption that each of the connection claws 52 is linearly bent about the bending point 412. As for the calculational bending angle θ, it is not necessary to take into account the amount of the pointed distal end 521 biting into the metal tubular member 31. The reason for defining a bending angle of the connection claw 52 by the calculational bending angle θ is that an actual bent portion of the connection claw 52 to be formed after actually pushing the ground plate 50 into the photosensitive drum 30 is not always formed in a linear shape and that the bending angle for obtaining a desired biting amount of the pointed distal end 521 cannot be defined.

The calculational bending angle θ at which each of the connection claws 52 is to be bent during the operation of attaching the ground plate 50 inside the photosensitive drum 30 is set in the range of 10 to 45 degrees, for the following reason.

If the calculational bending angle θ (see FIG. 6C) is set to be greater than 45 degrees, the connection claw 52 will be excessively bent to cause plastic deformation. In this case, a cutting force against the insulating film 33 to be generated by the pointed distal end 521 of the connection claw 52 becomes weak, i.e., the pointed distal end 521 of the connection claw 52 cannot effectively cut off the insulating film 33. This is likely to cause difficulty in bringing the pointed distal end 521 into contact with the inner peripheral surface of the insulating film 33. The non-contact state between the pointed distal end 521 and the inner peripheral surface of the insulating film 33 makes it impossible to obtain a function of removing charges in the metal tubular member 31 by grounding.

If the calculational bending angle θ is set to be less than 10 degrees, an amount of elastic deformation of the connection claw 52 will excessively decrease. Thus, the depth of a scratch to be formed in the insulating film 33 and the metal tubular member 31 as a result of cutting off by the pointed distal end 521 of the connection claw 52 will become shallow. This is likely to cause difficulty in obtaining desired electric connection between the metal tubular member 31 and the connection claw 52.

The lower and upper limit values of the calculational bending angle θ, i.e., 10 degrees and 45 degrees, have been determined based on a result of various actual experimental tests.

As described in detail above, the drum unit 20 according to the above embodiment of the present invention is designed to be used for forming on the outer peripheral surface an electrostatic latent image and a toner image in accordance with the electrostatic latent image. The drum unit 20 includes the cylindrical-shaped metal tubular member 31 having the insulating film 33 layered on the inner peripheral surface thereof, the flange member 40 attached to one end of the metal tubular member 31, and the ground plate 50 coaxially attached to the flange member 40 for removing electrostatic charges built up in the metal tubular member 31 for the purpose of grounding of the metal tubular member 31. The ground plate 50 has the connection claws 52 formed on the outer peripheral edge thereof, and each of the connection claws 52 is adapted to bite into the inner peripheral surface of the metal tubular member 31 so as to establish electrical connection between the metal tubular member 31 and the ground plate 50. The connection claw 52 is designed such that the distance between the center of the ground plate 50 and the pointed distal end 521 of the connection claw 52 in an unbent state is greater than the inner radius of the metal tubular member 31.

Thus, during an operation of inserting the ground plate 50 into the metal tubular member 31 while positioning the surface of the ground plate 50 in a direction perpendicular to the longitudinal axis of the metal tubular member 31, the connection claw 52 formed on the outer peripheral edge of the ground plate 50 is elastically deformed in a direction opposite to the insertion direction, and an elastic force caused by the elastic deformation allows the connection claw 52 to penetrate into the insulating film 33 and then bite into the inner peripheral surface of the metal tubular member 31 so that the ground plate 50 can be electrically connected to the metal tubular member 31 in a reliable manner through the connection claw 52 in the biting state. This makes it possible to reliably remove the electrostatic charges in the metal tubular member 31 through the ground plate 50 which is grounded via a given conductive wire or the like.

The calculational bending angle of the connection claw 52 is set in the range of 10 to 45 degrees. Thus, the connection claw 52 inserted into the metal tubular member 31 can maintain its elastic force as compared with a connection claw designed to have a calculational bending angle θ of less than 10 degrees or greater than 45 degrees. This makes it possible to increase the biting amount of the connection claw 52 into the inner peripheral surface of the metal tubular member 31, so that adequate electrical conduction between the metal tubular member 31 and the ground plate 50 can be ensured.

In the above embodiment, the metal tubular member 31 is made of aluminum or aluminum alloy, and an aluminum oxide film or an aluminum alloy oxide film is employed as the insulating film 33.

The aluminum oxide film or aluminum alloy oxide film is made from aluminum oxide (Al₂O₃) which is excellent in corrosion resistance and which is porous and excellent in cutting machinability. This makes it possible to ensure an adequate insulating effect in the inner peripheral surface of the metal tubular member 31. In addition, the oxide film on the inner peripheral surface of the metal tubular member 31 is easily cut off by the connection claw 52 to allow the connection claw 52 to readily come into contact with the inner peripheral surface of the metal tubular member 31. This makes it possible to ensure in a simplified manner reliable electrical conduction between the metal tubular member 31 and the ground plate 50.

In the above embodiment, the ground plate 50 is formed in an approximately circular shape and positioned in coaxial relation with the metal tubular member 31, and the connection claw 52 is provided in a plural number, wherein the plurality of connection claws 52 are disposed at even pitches along the circumferential direction of the ground plate 50. Thus, the electrical conduction between the metal tubular member 31 and the ground plate 50 can be ensured by bringing any of the connection claws 52 into contact with the inner peripheral surface of the metal tubular member 31. This makes it possible to avoid the occurrence of a problem that the metal tubular member 31 is not grounded.

In addition, since a plurality of the connection claws 52 are disposed at even pitches along the circumferential direction of the ground plate 50, a reaction force exerted from the inner peripheral surface of the metal tubular plate 31 during the operation of pushing the ground plate 50 into the metal tubular member 31 is applied to each of the connection claws 52 evenly. This makes it possible to stably support the ground plate 50 within the metal tubular member 31.

The present invention is not limited to the above embodiment, but also encompasses the following contents.

(1) While the above embodiment has been described as employing a tandem-type color printing apparatus as an image forming apparatus 10 to be equipped with the drum unit 20 of the present invention, the image forming apparatus 10 eligible to employ the present invention is not limited to the color printing apparatus. For example, the image forming apparatus 10 may be a so-called monochrome printing apparatus designed to print only in black.

(2) The image forming apparatus 10 illustrated in the above embodiment is not provided with a drum cleaning unit for cleaning the outer peripheral surface of the photosensitive drum 30 and a belt cleaning unit for cleaning the surface of the transfer belt 124. It is understood that the drum cleaning unit and/or the belt cleaning unit may be provided in the image forming apparatus 10.

(3) The above embodiment has been described as employing the copy machine as the image forming apparatus 10. Alternatively, the drum unit 20 of the present invention may be applied to a printer or a facsimile machine, instead of the copy machine.

(4) The above embodiment has been described based on one example where the photosensitive drum 30 having the organic photosensitive layer 32 layered on the outer peripheral surface of the metal tubular member 31 is employed in the form of a so-called OPC drum. Alternatively, a photosensitive drum having an amorphous silicon layer layered on the outer peripheral surface of the metal tubular member 31 may be employed, instead of the OPC drum.

(5) While the large-diameter shaft portion 71 of the drum shaft 70 in the above embodiment has the D-cut surface 711 formed in the end thereof on the side of the flange member 40, it is not essential to form the D-cut surface 711. Even if the D-cut surface 711 is omitted, the pointed distal end 521 of the connection claw 52 biting into the inner peripheral surface of the photosensitive drum 30 allows the flange member 40 to be rotated integrally with the drum shaft 70 about the axis of the photosensitive drum 30 through the ground plate 50.

(6) In the above embodiment, the photosensitive drum 30 is designed to be rotated by transmitting the driving force from the drive motor 80 to the drum shaft 70. Alternatively, the driving force of the drive motor 80 may be directly transmitted to the photosensitive drum 30 under conditions that the photosensitive drum 30 is coaxially attached to the drum shaft 70 in a rotatable manner relative to the drum shaft 70, and the drum shaft 70 is fixed. In this case, for example, the flange 62 of the shaft-supporting circular plate 60 may have an outer peripheral surface formed with gear teeth to transmit the driving force of the drive motor 80 to the photosensitive drum 30 through the gear teeth.

(7) In the above embodiment, the connection claw 52 of the ground plate 50 is formed in a triangular-shape. Alternatively, the connection claw 52 may be formed in any other suitable shape such as a pentagonal shape, having a pointed end which can be shaped into the pointed distal end 521.

(8) In the above embodiment, the outer diameter of the inner flange body 41 of the flange member 40 is set to be equal to the outer diameter of the ground-plate body 51. Alternatively, the outer diameter of the ground-plate body 51 may be set to be greater than the outer diameter of the inner flange body 41. In this case, the bending point 412 on the inner flange body 41 around which the connection claw 52 is bent faces the surface of the ground-plate body 51. Thus, during the operation of inserting the flange member 40 into the photosensitive drum 30 while the connection claws 52 being bent, the ground-plate body 51 also will be slightly bent in conjunction with the bending of the connection claw 52.

(9) In the above embodiment, the four connection claws 52 are formed to protrude from the outer peripheral edge of the ground-plate body 51. The number of connection claws 52 is not limited to four, but may be less than four or more than five.

### EXAMPLE 1

The ground plate 50 to be attached to the photosensitive drum 30 which has the outer diameter (D0 in FIG. 6A) of 24 mm and includes the metal tubular member 31 having the inner diameter (D3 in FIG. 6A) of 22.5 mm and the insulating film 33 having the thickness of 6 μm was actually prepared. After attaching the ground plate 50 inside the photosensitive drum 30 through the flange member 40, the press abutment of the pointed distal end 521 of each of the connection claws 52 against the inner peripheral surface of the photosensitive drum 30 was visually observed, and a conduction test was carried out to check electrical connection between the pointed distal ends 521 of each of the connection claws 52 and the inner peripheral surface of the metal tubular member 31.

Dimensions of the ground plate 50 were set as follows.
Distance (D in FIG. 6A) between the pointed distal ends 521 of the connection claws opposed to each other in the radial direction of the ground-plate body 51: 24 mm
Thickness of the ground-plate body 51: 0.25 mm
Outer diameter (D2 in FIG. 6A) of the ground-plate body 51: 20 mm
Diameter (D1 in FIG. 6A) of the insertion hole 511: 10 mm
Protruding distance [(D−D2)/2] of each of the connection claws 52 from the ground-plate body 51: 2 mm
Radial width (L in FIG. 6A) of the ground-plate body 51: 5 mm
Width (length on the outer peripheral edge of the ground-plate body 51) of the base of each of the connection claws 52: 3 mm

Dimensions of the flange member 40 to which the ground plate 50 is attached were set as follows.
Outer diameter of the inner flange body 41: 17 mm
Outer diameter of the outer flange body 42: 22.5 mm

The bending point 412 about which each of the connection claws 52 is to be bent was not aligned with the outer peripheral edge of the ground-plate body 51, that is, the base of the connection claw 52, and was positioned facing a portion of the surface of the ground-plate body 51, which portion is slightly away in distance from the outer peripheral edge of the ground-plate body 51. Thus, after the ground plate 50 is attached to the flange member 40, a distance between the bending point 412 and the pointed distal end 521 is (24−17)/2=3.5 mm.

The calculational bending angle θ of the connection claw 52 to be bent about the bending point 412 after the ground plate 50 having the above dimensions was attached to the flange member 40 was calculated. The calculational bending angle θ was calculated as follows:

$$\begin{matrix}θ = arc [ cos \{ ( ( 22.5 - 17 ) / 2 ) / 3.5 \} ] \\ = arc [ cos ( 2.75 / 3.5 ) ] \\ = arc [ cos 0.786 ] \\ = 38.2 degrees\end{matrix}$$

This value of the calculational bending angle θ falls within the range of 10 to 45 degrees defined by the present invention.

In the Example 1, the ratio (2L/D1) of the diametric dimension (2L) of the ground-plate body 51 except the diameter of the insertion hole 511 to the diameter D1 of the insertion hole 511 is 10/10=1. This means that a solid portion of the ground-plate body 51 becomes smaller, because, in the case where the image forming apparatus 10 is a color printing apparatus, even if the photosensitive drum 30 is reduced in size, the diametric dimension of the drum shaft 70 cannot be reduced in proportion to a reduction in the diametric dimension of the photosensitive drum 30 in view of the need for suppressing deflection in rotation of each of the photosensitive drums 30 so as to accurately rotate the photosensitive drums 30 while ensuring synchronization therebetween.

This also means that each of the connection claws 52 is easily deformed by a reaction force exerted from the inner peripheral surface of the photosensitive drum 30 after the ground plate 50 is inserted into the photosensitive drum 30, and it is thus difficult to ensure electrical conduction between the connection claws 52 and the metal tubular member 31. The inventors of this application found that when the calculational bending angle of the connection claw 52 is set to fall within the range of 10 to 45 degrees, the electrical conduction can be reliably ensured even using the ground plate 50 liable to be easily deformed. Based on this knowledge, the present invention has been accomplished.

### EXAMPLE 2

The ground plate 50 shown in the Example 1 was subjected to a test for checking a relationship between the calculational bending angle θ of the connection claw 52 and the depth of a scratch formed in the metal tubular body 31 by the connection claw 52. In this test, the outer diameter D2 of the ground-plate body 51 was changed to set the calculational bending angle θ of the connection claw 52 at various values.

After attaching each of the ground plates 50 to a flange member 40 having a bending point 412 corresponding to the calculational bending angle θ of the connection claw 52, the flange member 40 was inserted into the photosensitive drum 30. Then, the depth of a scratch formed in the metal tubular member 31 as a result of cutting off of the insulating film 33 and the photosensitive drum 30 by the pointed distal end 521 of the connection claw 52 was measured by a three-dimensional interference microscope (Model No. Wyko-NT-1100 produced by Japan Veeco Instruments Inc.), and electrical conduction between the metal tubular member 31 and the connection claw 52 was measured and evaluated.

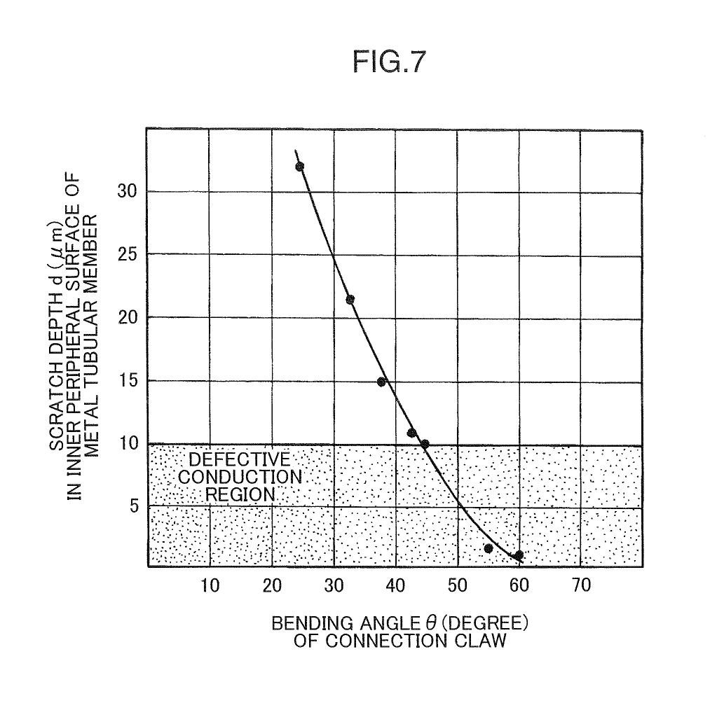

FIG. 7 is a graph showing the measurement results, wherein the horizontal axis represents the calculational bending angle θ (degree) of the connection claws 52, and the vertical axis represents the scratch depth d (μm) in the inner peripheral surface of the metal tubular member 31.

As seen in the graph, when the calculational bending angle θ of the connection claw 52 is set at 25 degrees, the metal tubular member 31 has a fairly large scratch depth of 34.0 μm. Then, the scratch depth d decreases in the form of a quadratic curve, along with an increase in the calculational bending angle θ.

It was observed that when the scratch depth d is reduced to less than 10 μm, the electrical conduction between the metal tubular member 31 and the connection claw 52 becomes defective. Further, in the graph of FIG. 7, when the calculational bending angle θ becomes greater than 45 degrees, the scratch depth d is reduced to less than 10 μm. That is, if the calculational bending angle θ becomes greater than 45 degrees, a defect in electrical conduction will occur between the metal tubular member 31 and the connection claw 52. Thus, it was verified that the calculational bending angle θ of the connection claw 52 can be set to be 45 degrees or less to avoid the occurrence of the defective electrical conduction.

Through visual observation, it could be proven that if the calculational bending angle θ of the connection claw 52 is set to be less than 10 degrees, the pointed distal end 521 of the connection claw 52 fails to reach the metal tubular member 31 due to an excessively small bending amount of the connection claw 52 although only the insulating film 33 in the inner peripheral surface of the photosensitive drum 30 is partially cut off by the pointed distal end 521, and thus the electrical conduction between the metal tubular member 31 and the connection claw 52 cannot be obtained. Based on this observation result, the calculational bending angle θ of the connection claw 52 is set to be 10 degree or more.

If the ratio 2L/D1 is less than 1, the solid portion of the ground-plate body 51 will be excessively reduced in size to cause an increase in deformation of the ground plate 50 during the operation of inserting the flange member 40 into the photosensitive drum 30 under press fit. If the ratio 2L/D1 is greater than 1.5, the drum shaft will be excessively thinned to increase the risk of occurrence of deflection in rotation of the photosensitive drum 30. Thus, the ratio 2L/D1 is preferably set in the range of 1 to 1.5.

When the ratio D/D2 becomes greater than 1.3 even if it is set in the range of 1 to 1.5, the connection claw 52 will be excessively increased in size, and the solid portion of the ground plate 50 will be excessively reduced in size. Thus, the ground plate 50 becomes liable to be deformed. Moreover, when the bending point is set at a fixed position, the calculational bending angle θ will be excessively increased due to an increase in radial length of the connection claw 52. Thus, the ratio 2L/D1 is more preferably set in the range of 1 to 1.3.

This application is based on Japanese patent application serial no. 2007-028090, filed in Japan Patent Office on Feb. 7, 2007, the contents of which are hereby incorporated by reference.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A drum unit for forming a toner image, comprising:
a cylindrical-shaped metal tubular member having an outer peripheral surface on which the toner image is formed and an inner peripheral surface formed with an insulating film;
a flange member attached to one end of the metal tubular member; and
a ground plate attached to the flange member for removing electrostatic charges charged in the metal tubular member, the ground plate having an outer peripheral edge formed with a connection claw that is so bent by the inner peripheral surface of the metal tubular member as to bite into the inner peripheral surface of the metal tubular member for establishment of electrical conduction between the metal tubular member and the ground plate,
wherein the flange member has an edge, and the bending of the connection claw is carried out about a support point defined by the edge of the flange member; and
wherein a calculational bending angle at which the connection claw is bent about the support point is set in the range of 10 to 45 degrees.

2. The drum unit as defined in claim 1, wherein the metal tubular member is made of aluminum or aluminum alloy; and
wherein the insulating film is an aluminum oxide film or an aluminum alloy oxide film.

3. The drum unit as defined in claim 1, wherein the ground plate is formed in an approximately circular shape and is so attached to the flange member as to be in coaxial relation with the metal tubular member; and
wherein the connection claw is provided in a plural number, the plurality of connection claws disposed at even pitches along a circumferential direction of the ground plate.

4. The drum unit as defined in claim 3, wherein the connection claw is provided in a number of four; and
wherein four connection claws are disposed at even pitches along the circumferential direction of said ground plate, each of said connection claws having a distal end formed in a pointed shape capable of biting into the inner peripheral surface of the metal tubular member.

5. The drum unit as defined in claim 1, further comprising a shaft member which is inserted into the metal tubular member for integral rotation with the metal tubular member; and
wherein the flange member and the ground plate are coaxially attached to said one end of metal tubular member.

6. The drum unit as defined in claim 5, wherein the shaft member serves as a grounding path.

7. An image forming apparatus comprising:
a drum unit for forming a toner image based on image data; and
a transfer member for transferring the toner image onto a sheet,
the drum unit including:
a cylindrical-shaped metal tubular member having an outer peripheral surface on which the toner image is formed and an inner peripheral surface formed with an insulating film;
a flange member attached to one end of the metal tubular member; and
a ground plate attached to the flange member for removing electrostatic charges charged in the metal tubular member, the ground plate having an outer peripheral edge formed with a connection claw that is so bent by the inner peripheral surface of the metal tubular member as to bite into the inner peripheral surface of the metal tubular member for establishment of electrical conduction between the metal tubular member and the ground plate,
wherein the flange member has an edge, and the bending of the connection claw is carried out about a support point defined by the edge of the flange member; and
wherein a calculational bending angle at which the connection claw is bent about the support point is set in the range of 10 to 45 degrees.

8. The image forming apparatus as defined in claim 7, wherein the metal tubular member is made of aluminum or aluminum alloy; and
wherein the insulating film is an aluminum oxide film or an aluminum alloy oxide film.

9. The image forming apparatus as defined in claim 7, wherein the ground plate is formed in an approximately circular shape and is so attached to the flange member as to be in coaxial relation with the metal tubular member; and
wherein the connection claw is provided in a plural number, the plurality of connection claws disposed at even pitches along a circumferential direction of the ground plate.

10. The image forming apparatus as defined in claim 9, wherein the connection claw is provided in a number of four; and
wherein four connection claws are disposed at even pitches along the circumferential direction of said ground plate, each of said connection claws having a distal end formed in a pointed shape capable of biting into the inner peripheral surface of the metal tubular member.

11. The image forming apparatus as defined in claim 7, further comprising a shaft member which is inserted into the metal tubular member for integral rotation with the metal tubular member; and
wherein the flange member and the ground plate are coaxially attached to said one end of metal tubular member.

12. The image forming apparatus as defined in claim 11, wherein said shaft member serves as a grounding path.
